(19) United States
(12) Patent Application Publication
(10) Pub. No.: US 2017/0317365 A1
(43) Pub. Date: Nov. 2, 2017

(54) METHOD FOR OPERATING A FUEL CELL SYSTEM

(71) Applicant: FORD GLOBAL TECHNOLOGIES, LLC, Dearborn, MI (US)

(72) Inventors: Stephan STRAHL, Herzogenrath NRW (DE); Arnulf SPONHEIMER, Aachen NRW (DE); Uwe GUSSEN, Huertgenwald NRW (DE)

(73) Assignee: FORD GLOBAL TECHNOLOGIES, LLC, Dearborn, MI (US)

(21) Appl. No.: 15/498,170

(22) Filed: Apr. 26, 2017

(30) Foreign Application Priority Data
Apr. 29, 2016 (DE) 102016207366.4

(51) Int. Cl. H01M 8/04492; G01L 1/18; H01M 8/04701; H01M 8/04746; G01L 5/00; H01M 8/1018

(52) U.S. Cl. CPC H01M 8/04529; H01M 8/04753; G01L 5/0038; G01L 1/18; H01M 8/04708; H01M 2008/1095; H01M 2250/20

(57) ABSTRACT

A method comprising feeding a fuel and an oxidant to individual cells in a fuel cell stack, each having two electrode layers and an electrolyte layer arranged between the electrode layers. The method further includes compressing the cell stack with a clamping device, and detecting a compression pressure upon the cell stack with at least one pressure sensor. The method also includes determining a moisture content of the two electrolyte layers based on the detected compression pressure.

### CROSS-REFERENCE TO RELATED APPLICATIONS

This application claims foreign priority benefits under 35 U.S.C. §119(a)-(d) to DE Application 10 2016 207 366.4 filed Apr. 29, 2016, which is hereby incorporated by reference in its entirety.

### TECHNICAL FIELD

The invention relates to a method for operating a fuel cell system and to a fuel cell system having a cell stack of individual cells, arranged next to each other, and a clamping device for compressing the cell stack.

### BACKGROUND

A fuel cell system customarily contains a cell stack with a multiplicity of individual cells arranged next to each other. In each individual cell, chemical energy is directly converted into electrical energy because of a reaction of a fuel with an oxidant. An electrolyte layer is provided in the individual cells between two layers, which are formed as electrodes.

The electrolyte layer can be formed as a polymer membrane containing water. Fuel, which is dissolved in the water, is disassociated on the anode side of the electrode. An example of a fuel is hydrogen. Protons, which are created in the process, diffuse through the membrane to the cathode side of the electrode and react there with the oxygen of the oxidant, which is reduced by the cathode. Internal charge transport of oxonium ions is facilitated by water on the anode side and the water is released again on the cathode side.

An inadequate moisture content of an electrolyte layer leads to, among other things, a lower ion conductivity and therefore to lower efficiency of the fuel cell system. On the other hand, because of an excessively large moisture content, the supply of the electrode layers with fuel or oxidant is negatively influenced. Therefore, a diffusion process of the fuel or oxidant to the electrode layers or the feed of these substances to the individual cells into feed lines can be impeded. For an efficient operation of the fuel cell system, control of the moisture content during an operation is therefore desired. A change of the moisture content of the electrolyte layers can be achieved, for example, by an adjustment of humidification or flow rate of the oxidant or of the fuel.

For such a control of the moisture content, sufficiently accurate knowledge of the currently existing moisture content in the individual cells during operation is especially important. Conventional measuring methods and sensors for determining the moisture content are of only poor suitability especially for mobile applications of a fuel cell system since they are excessively failure-prone, complex or expensive.

WO 2007/083235 A2 proposes to detect the electric voltage which is generated by each individual cell in addition to an electric voltage which is generated by the entire cell stack. If the difference between the lowest voltage from an individual cell and the voltage generated on average by the individual cells is greater than a predetermined threshold value, a deficient moisture content is established. For differentiating between an excessively high or excessively low moisture content, for example, the flow rate of the oxidant is then increased. A higher flow rate of the oxidant leads to a lowering of the moisture content since for example water vapor as the reaction product of the fuel cell system is increasingly discharged. If now the difference between the lowest individual cell voltage and the average voltage still lies above a threshold value, an excessively low moisture content is established. In addition, with this method a temperature of the cell stack which is detected by a temperature sensor can be taken into consideration.

US 2003/0157392 A1 discloses a method for establishing and regulating a moisture content of a fuel cell system. In the feed and discharge lines of air as oxidant, porous materials as a water reservoir and hygrometers for measuring the moisture content of the air are provided in each case. The air which is discharged by the individual cells first yields water to the water reservoir, which is provided in the discharge line. If a hygrometer in the discharge line determines a moisture content of the air above a predetermined threshold value, a saturated water reservoir is assumed and the flow direction of the air is reversed. The supplied air now extracts the water from the saturated water reservoir which lies upstream of the individual cells and, after a reaction in the individual cells, yields it to a water reservoir which is now located in the discharge line. In the case of an excessively high moisture content of the discharged air, the flow direction is again changed. Alternatively, the water content of a water reservoir is also determined by detecting the expansion of the porous material by strain gauges or optical barriers or by detecting the electric voltage which is provided by the individual cells.

The known methods for operating a fuel cell system have the disadvantage that a sufficiently accurate determination of the moisture content of individual cells is excessively complex, material-intensive and costly. Therefore, for example, for each of possibly more than one hundred individual cells a voltage sensor must be provided for detecting the individual cell voltage and must be connected via signal lines to a processing unit.

### SUMMARY

An object of the present invention is to provide a method for operating a fuel cell system and to provide a fuel cell system in which the disadvantages referred to are avoided or at least lessened and in which a reliable, simply constructed and inexpensive determination of a moisture content of individual cells is made possible even during an operation.

In a method according to one or more embodiments for operating a fuel cell system, fuel and oxidant is fed to a multiplicity of individual cells, arranged next to each other in a cell stack, having in each case two electrode layers and an electrolyte layer which is arranged between the electrode layers. The feeding of fuel and oxidant to the individual cells and discharging of reaction products and surplus oxidant is carried out via correspondingly designed lines or passages. A flow rate of a fuel or of an oxidant can be established. For this purpose, for example, control valves or the like can be provided. A common separating plate between two adjacent individual cells, commonly referred to as a bipolar plate, with passages for feeding source substances and for discharging reaction products can also be used.

In addition to the electrode layers and the electrolyte layer, the individual cells which are used for a method per one or more embodiments can have additional plates, laminations or layers, such as gas diffusion layers (GDL) for the uniform distribution of the fuel and the oxidant, separating layers for delimiting individual cells which are adjacent to each other, or sealing layers for preventing an escape of fuel, oxidant or electrolytic liquid. The laminations, plates or layers of an individual cell are especially in a sandwich-like arrangement and at the edge can be encompassed by seals.

Proton exchange membrane fuel cells or other cell types can be used as individual cells. In this case, hydrogen or a gaseous hydrocarbon, such as methane, can be used as fuel, and air for example is used as the oxidant. The individual cells can be arranged next to each other in sandwich-like manner as a cell stack so that an electrical series connection of the individual cells is formed.

A method per one or more embodiments furthermore includes compression of the cell stack during an operation by a clamping device. The clamping device can include one or more clamping bolts, one or more clamping bands, a frame or a combination of these elements, as a clamping element. One or more of the pressure elements which are fixed by the clamping elements can act upon one end or both ends of the cell stack. Provided as pressure elements are for example passive spring elements or actively controllable actuators on an electrical, hydraulic or pneumatic basis. By the clamping device, a flexible holding together and compression of the cell stack of individual cells during varying expansions is especially ensured.

A detection of a compression pressure upon the cell stack is carried out during an operation of at least one pressure sensor. The pressure sensor is for example arranged on or in the cell stack and continuously or periodically detects the pressure with which the clamping device acts upon the cell stack. Depending on the detected compression pressure or a time change of the compression pressure, the pressure sensor includes corresponding electronic signals for further processing.

Finally, determination of a moisture content of electrolyte layers based on the detected compression pressure is carried out. Provided for this is for example a control device which contains an electronic processor for processing data and a data memory for storing data. The determination of the moisture content can be carried out with the aid of a previously determined relationship between the compression pressure or a time change of the compression pressure and the moisture content in the respectively used cell stack in a computerized or tabular manner. In this case, further operating parameters, such as a current energy extraction or a current load, an ambient temperature, current flow rates for a fuel or an oxidant and so forth can be taken into consideration.

In one or more embodiments, the method for operating a fuel cell system is designed for mobile applications, for example for generating electric energy in motor vehicles. By determination of moisture content of individual cells, which can be carried out in an uncomplicated and reliable manner at any time, an optimum moisture content can be established and therefore an operation which is as efficient as possible can be realized. Damage to individual cells because of a false moisture content is reliably prevented.

In one embodiment, the detection of the compression pressure is carried out with the aid of a pressure sensor which is provided between one end of the cell stack and the clamping device. The pressure sensor is provided for example between an end plate of the cell stack and the clamping device. The end plate can include a base area which corresponds to or is like the cross section of the cell stack and serves for the homogenous distribution of the pressure which is created by the clamping device upon the end of the cell stack. By this measure, the compression pressure which acts upon the cell stack by the clamping device can be precisely determined. Alternatively, a plurality of pressure sensors can be provided on one end of the cell stack or pressure sensors can also be provided on both ends of the cell stack. Per one embodiment, provision is especially made for four pressure sensors for each corner region of a basically rectangular end plate.

Per an embodiment, at least one piezo element is provided as a pressure sensor for detecting the compression pressure. The piezo element contains for example a piezo crystal, a piezo-electric ceramic, or a stack of individual elements made from these materials. Depending on the applied pressure, a corresponding electric voltage is generated in piezo-electric materials. A detection of the pressure is carried out by measuring the occurring electric voltage. One or more piezo elements are arranged for example between two individual cells of the cell stack, between an end plate and the cell stack, or in a clamping device for the fuel cell system. Using a piezo element, a reliable and precise pressure measurement in a determined region of the cell stack is possible.

Per another embodiment, at least one piezo element is additionally used for creating a compression pressure upon the cell stack. Depending on the applied electric voltage, piezo-electric materials assume a different volume. Depending on the applied electric voltage, the piezo element creates a higher or lower pressure upon the cell stack. In one of a plurality of regions of the end plate in each case, compression pressure is created and detected by a piezo element. Per one embodiment, in both end plates compression pressure is detected and measured by a plurality of piezo elements in each case, especially four piezo elements in each case. Different regions of the end plates, and therefore different longitudinal regions of the cell stack, can be acted upon by a different pressure in this way. Therefore, for example an inhomogeneous thermal expansion over a cross section of the cell stack because of variable heating during an operation can be compensated. In addition, detection of the compression pressure in different regions of an end plate is possible, because of which the accuracy of detection is increased. Furthermore, in one embodiment provision is made between the piezo elements and an end plate for a lever mechanism for boosting travel ranges. Because of the double function of the piezo element(s), a particularly inexpensive method for operating a fuel cell system is achieved.

In this case, per one embodiment, detection of the compression pressure based on the electric voltage which is applied for creating the compression pressure by the piezo element is carried out. The electric voltage which is used for creating the pressure is predetermined by a control device. The voltage values which are used here are used directly by the control device for determining the moisture content. Because of this, the moisture content can be determined in a particularly simple and reliable manner.

In a further embodiment, a temperature of the cell stack is detected by a temperature sensor and the detected temperature is taken into consideration when determining the moisture content of electrolyte layers. Used as a temperature sensor is for example an electric temperature sensor on a resistance basis or semi-conductor basis which is arranged in or on the cell stack. An arrangement of a plurality of temperature sensors at different locations of the cell stack is also possible. Since an expansion of the cell stack and therefore also the compression pressure upon these can also be dependent on the temperature in addition to the moisture content, by detecting and taking into consideration the temperature a precise determination of the moisture content of electrolyte layers of the individual cells is carried out.

Furthermore, in one embodiment, an adjustment of operating parameters of the fuel cell system during an operation is carried out by a control device taking into consideration the determined moisture content of electrolyte layers. In this case, a controlling of operating parameters, such as flow rates, temperature or pressure of fuel or oxidant is carried out to constantly achieve an optimum moisture content and operation of the fuel cell system. For this purpose, the control device can contain an electronic processor for processing data and a memory for storing data. In addition to a processing of one or more moisture contents, consideration of values of additional sensors, such temperature sensors, voltage sensors or current sensors, can additionally be provided.

Furthermore, an object is achieved by a fuel cell system with a cell stack of individual cells, arranged next to each other, and a clamping device for compression of the cell stack. Each individual cell has two electrode layers and an electrolyte layer which is arranged between the electrode layers. The fuel cell system contains at least one pressure sensor for detecting a compression pressure upon the cell stack. Furthermore, a control device is provided for determining a moisture content of one or more electrolyte layers based on the detected compression pressure.

In one embodiment, using the inventive fuel cell system a reliable and inexpensive determination of the moisture content of individual cells or their electrolyte layer is made possible at any time during operation. Based on the determined moisture content, for example a controlling of operating parameters can be carried out to therefore ensure a constantly optimum moisture content and operation of the fuel cell system.

Further embodiments of the fuel cell system per the invention correspond in each case to described embodiments of the method for operating a fuel cell system and have corresponding features and advantages.

The previous and further advantageous features of the invention are explained in more detail in the subsequent detailed description of exemplary embodiments per the invention regarding the attached schematic drawings.

### BRIEF DESCRIPTION OF THE DRAWINGS

FIG. 1 shows an exemplary embodiment of a fuel cell system per one embodiment in a schematic side view,

FIG. 2 shows a schematic top view of one end of the fuel cell system per FIG. 1, with the clamping plate not shown, and

FIG. 3 shows a schematic diagram of an exemplary embodiment of the method according to the invention for operating a fuel cell system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of components. Therefore, specific structural and functional details disclosed herein are not to be interpreted as limiting, but merely as a representative basis for teaching one skilled in the art to variously employ the present invention.

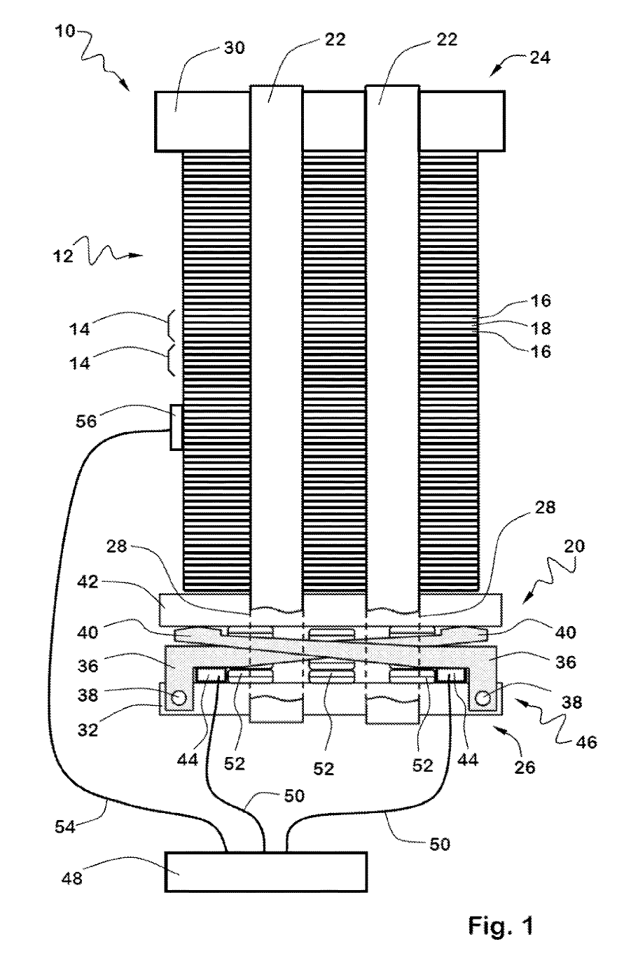

In FIG. 1, a schematic side view of a fuel cell system 10 is shown. The fuel cell system 10 comprises a cell stack 12 with a multiplicity of individual cells 14 which are arranged next to each other. The individual cells 14 are arranged in a sandwich-like manner one on top of the other by their large oppositely disposed lateral surfaces so that an electrical series connection of the individual cells 14 is realized. An electrical parallel connection of a plurality of individual cells 14 of the cell stack 12 in each case is also possible. Each individual cell 14 is supplied via passages or lines (not shown) of the fuel system 10 with fuel, for example hydrogen, methane or another gaseous hydrocarbon, and with oxidant, for example oxygen or air. Correspondingly provided for each fuel cell 14 is a discharge line (not shown in FIG. 1) for reaction products and unconsumed oxidant. An electric voltage or energy which is generated by the cell stack 12 is provided at both ends of the cell stack 12 by electrical contacts (similarly not shown). The fuel cell system 10 in this exemplary embodiment is designed for a mobile application, for example in a vehicle, and is configured in the easiest and most space-saving manner possible for this purpose.

For generating electric energy, each individual cell 14 contains in each case two electrode layers 16 and an electrolyte layer 18 arranged between them. In addition, each individual cell 14 can contain additional laminations, layers or plates, for example gas diffusion layers (GDL) arranged on the electrode layers 16 for uniform distribution of fuel and oxidant over the entire surfaces of the electrode layers 16, and separating plates for separation of the individual cells 14. In this case, an individual separating plate, a so-called bipolar plate, can be provided for two adjacent individual cells 14. Moreover, passages for the feed of fuel and oxidant and for the discharge of reaction products and unconsumed oxidant can be contained in the separating plates. Furthermore, for each individual cell 14 seals are provided on the outer edge of the cell stack 12 or as additional plates or layers to prevent escape of fuel, oxidant, reaction products or an electrolytic fluid from the cell stack 12. The individual cells 14 are designed for example as a proton exchange membrane fuel cells with a proton exchange membrane (PEM) as the electrolyte layer, to name only one of many individual cell types, which can be used in the fuel cell system 10.

For the compression and holding together of the cell stack 12, the fuel cell system 10 also contains a clamping device 20. The clamping device 20 has four clamping elements 22, designed as clamping bands, which extend in each case from a first end 24 of the fuel cell system 10 to a second end 26. The clamping elements 22 are arranged in pairs in oppositely disposed sides of the cell stack 12 and extend parallel to each other and to the longitudinal axis of the cell stack 12. Shown in FIG. 1 are two clamping elements 22 with sections 28 removed at the two ends 26 of the fuel cell system 10 to therefore expose elements and structures which lie behind. The four clamping elements 22 hold in each a first clamping plate 30 on the first end 24 and a second clamping plate 32 on the second end 26 of the fuel cell system 10 at a fixed maximum distance apart. In alternative embodiments, more or less than four clamping bands can be used, instead of two clamping bands one clamping band which can be guided in a loop-like manner around both ends 24, 26 and along two oppositely disposed sides can be used, or instead of clamping bands clamping bolts can be used. A rigid frame with integrated clamping elements and clamping plates is also possible. It is only important that the clamping plates 30, 32 have a fixed distance apart to thereby constitute an abutment for creating pressure upon the cell stack 12.

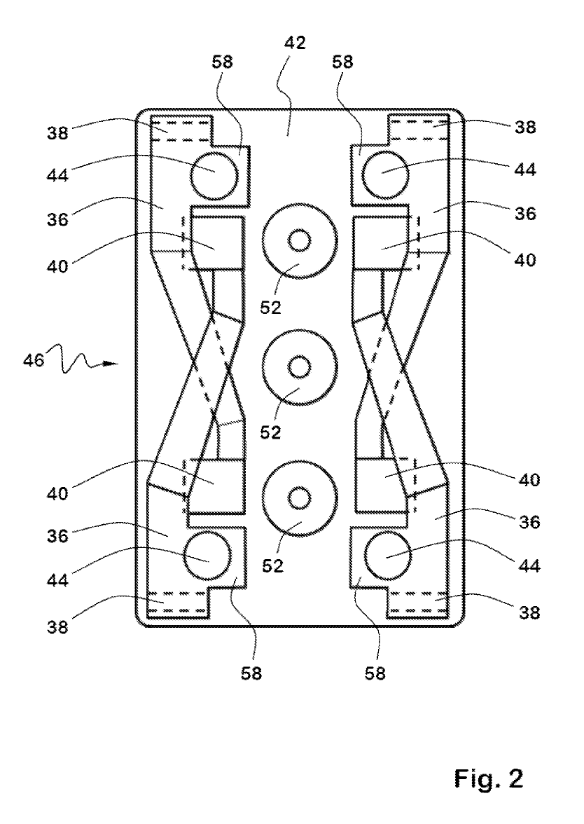

Four levers 36, of which only two are visible in FIG. 1, are pivotably fastened via joints 38 on the second clamping plates 32. By their free end 40, the levers 36 butt against an end plate 42 which uniformly transmits force from the levers 36 onto one end of the cell stack 12 and vice versa. For this, the end plate 42 which is provided on the second end 26 of the cell stack 12 butts against the cell stack over the entire area of the end of said cell stack 12 and has a base area which corresponds to or is like the cross section of the cell stack 12. Arranged in each lever 36, close to the joint 38, between a bearing surface 58 (see FIG. 2) of the lever 36 and the second clamping plate 32, is a piezo element 44. The piezo elements 44 serve both for detecting and for creating compression pressure upon the cell stack 12. Depending on the variable expansion of a piezo element 44, the corresponding lever 36 is pressed by a greater or lesser degree of force against the end plate 42. The levers 36 therefore constitute a one-sided lever which converts a small expansion of the piezo elements 44 into a larger deflection at the free ends 40 of the levers 36. Conversely, the levers 36 transmit the compression pressure which acts upon the cell stack 12 onto the piezo elements 44. The second clamping plate 32, together with the levers 36 and the joints 38, constitutes a lever mechanism 46 for the piezo elements 44. In an alternative exemplary embodiment, piezo elements and levers are also provided in the first clamping plate 30. Therefore, detection and creation of compression pressure is possible at both ends of the cell stack 12. In further alternative exemplary embodiments, more or less than four piezo elements 44 or levers 36 can be provided on one end 24, 26 or even a two-sided lever instead of a one-side lever.

Each of the four piezo elements 44 in this exemplary embodiment contains a piezo crystal, a piezo-electric ceramic, or a stack of individual elements made from these materials. Depending on the applied electric voltage, piezo-electric materials assume a different volume. By the same token, piezo-electric materials under pressure generate a corresponding electric voltage. Each piezo element 44 can be individually operated by a control device 48 of the fuel cell system 10 by adjustment of a corresponding electric voltage. For this purpose, the piezo elements 44 are connected via electric leads 50 to the control device 48. In this way, the pressure upon the cell stack 12 can be separately adjusted in the region of each corner of the cell stack 12. Furthermore, the piezo elements 44 and the control device 48 are also provided for measuring a pressure. Therefore, in each corner of the cell stack 12 detection of the pressure which acts via the end plate 42 and the lever 36 upon the piezo element 44 can also be carried out instead of creating pressure. Furthermore, in this exemplary embodiment spring elements 52 are arranged at the second end 26 between the clamping plate 32 and the end plate 42 for additional pressing of the end plate 42 against the cell stack 12. The spring elements 52 are designed for example as disk springs or coil springs.

The control device 48 is designed for determining a current moisture content of electrolyte layers 18 and to this end also use a current temperature or temperature change at one or more locations of the cell stack 12 in addition to the compression pressure currently acting upon the cell stack 12 or a time change of the this pressure. For this, the control device 48 is connected via an electrical connection 54 to at least one temperature sensor 56. The pressure in each piezo element 44 is determined by the control device 48 directly from the voltage which is used for creating pressure. Alternatively, a voltage which is generated by the piezo elements 44 can also be used for determining the pressure. Furthermore, a determination of the moisture content by a separate calculation device which is separate from the control device 48 is also possible.

For operating the piezo elements 44 with a corresponding electric voltage, the control device 48 takes into consideration for example a current energy extraction, an ambient temperature, the temperature which is determined by the temperature sensor 56, a previously determined moisture content, a pressure inside the fuel cell system 10, a pressure in a region of the end plate 42, a flow rate, temperature or a moisture content of fuel or oxidant and so forth. To this end, the control device 48 can also be designed for processing values of additional sensors, such as temperature sensors, pressure sensors, strain sensors, current sensors or voltage sensors, and contains an electronic processor for processing data and also a memory for storing data. By processing values which are made available, the control device 48 first of all determines current moisture contents of individual cells 14 and then, depending on the operating state, adjusts operating parameters of the fuel cell system 10, for example the compression pressure in each piezo element 44 or the flow rate, the temperature, the moisture content or the pressure of fuel and oxidant so that an optimum moisture content and operation of the fuel cell system 10 is achieved and maintained.

FIG. 2 shows a schematic top view of the second end 26 of the fuel cell system 10 according to FIG. 1 without the second end plate 32. Each lever 36, at one end in the region of a corner of the end plate 42, is connected via the joint 38 to the second end plate 32, which is not shown. As a joint 38, provision is made for example for a pin which is fastened on the clamping plate 32 and extends in a hole in the lever 36. The pivot axes of the lever 36 are therefore parallel to the dashed lines in the joints 38. Furthermore, each lever 36 extends along a side edge of the end plate 42 up to the opposite corner of the end plate 42 where the free end 40 of the lever 36 acts upon the end plate 42 by a lever head. In this case, two levers 36 are arranged in each case in a crosswise manner and are designed so that they are not mutually limited in their freedom of movement.

Adjacent to the joint 38, each lever 36 has a contact face 58 against which butts the respective piezo element 44. The piezo elements 44 are held in position by the second clamping plate 32 which in turn is fixed by the clamping elements 22. Because of such an arrangement of the levers 36 and piezo elements 44, a very compact and space-saving clamping device 20 is realized and at the same time is suitable for detecting a compression pressure. In this case, because of the levers 36 being designed if possible piezo elements 44 with small travel ranges and therefore small dimensions are indicated. Furthermore, three spring elements 52, designed for example as disk springs or coil springs, are arranged in the middle of the end plate 42. Alternatively, more or less than three spring elements 52 can also be provided. The spring elements 52 exert an additional pressure upon the end plate, especially in the middle region of this end plate 42.

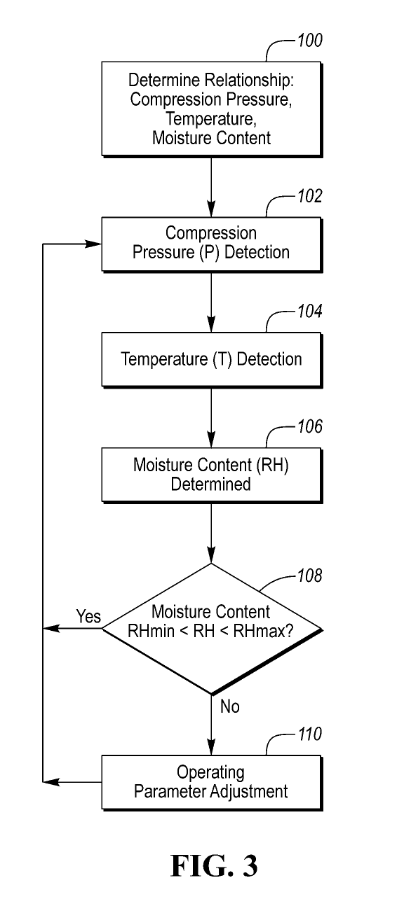

FIG. 3 shows a schematic diagram of a method for operating the fuel cell system 10. First, a determination 100 of a relationship between a compression pressure, a temperature and a moisture content of a determined cell stack 12 in use, consisting of individual cells 14, is carried out during a test operation. In this case, a dependency of the compression pressure or of its change on a moisture content and a temperature of the cell stack 12 can be determined. The relationship can be stored as an algorithm or table in a memory of the control device 48 and enables a determination of a current moisture content of electrolyte layers 18 or of individual cells 14 of the cell stack 12 during an operation.

For this, a periodic or continuous detection 102 of the current compression pressure P by the piezo elements 44 is carried out by the control device 48 during operation of the fuel cell system by feeding fuel and oxidant. A periodic or continuous detection 104 of at least a current temperature T of the cell stack 12 is also carried out with the aid of the temperature sensor 56. The control device 48, using the detected compression pressure P, or its change rate, and the detected temperature T, or its change, carries out a determination of a current moisture content RH of electrolyte layers 18 or of individual cells 14 based on the stored relationship.

The determined moisture content RH is compared with a predetermined, optimum value range of the moisture content for the current operating state of the fuel cell system, 108. If the determined moisture content RH lies within the predetermined value range, the method is continued with a new detection 102 of the compression pressure. If the determined moisture content RH is outside the predetermined value range, therefore above an upper threshold value RHₘₐₓ or below a lower threshold value RHₘᵢₙ, an adjustment 110 of operating parameters, such as flow rate, temperature, moisture content or pressure of the oxidant or of the fuel, is carried out with the aid of the control device 48. The method is then continued with a new detection 102 of the compression pressure. In this way, a control for the moisture content during an operation is realized. The fuel cell system 10 is constantly operated with an optimum moisture content of the cell stack 12. In addition, a suitable compression pressure upon the cell stack 12 can be established by the clamping device 20 at any time.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method comprising:
feeding a fuel and an oxidant to individual cells in a fuel cell stack, each having two electrode layers and an electrolyte layer arranged between the electrode layers;
compressing the cell stack with a clamping device;
detecting a compression pressure upon the cell stack with at least one pressure sensor; and
determining a moisture content of the two electrolyte layers based on the detected compression pressure.

2. The method of claim 1, wherein the at least one pressure sensor is situated between an end of the cell stack and the clamping device.

3. The method of claim 1, wherein the at least one pressure sensor is an at least one piezo element.

4. The method of claim 3, wherein the at least one piezo element is configured to create the compression pressure upon the cell stack.

5. The method of claim 4, further comprising detecting a compression pressure based on an electric voltage which is used by the at least one piezo element for creating the compression pressure.

6. The method of claim 1, further comprising detecting a temperature of the cell stack with a temperature sensor.

7. The method of claim 6, wherein the determining step includes determining the moisture content of the two electrolyte layers based on the detected compression pressure and the detected temperature.

8. The method of claim 1, further comprising adjusting one or more operating parameters of the cell stack with a control device based on the moisture content.

9. The method of claim 1, wherein the one or more operating parameters include a cell stack flow rate, a cell stack temperature, a cell stack moisture content, and/or a cell stack pressure.

10. A fuel cell system comprising:
a cell stack including individual cells of two electrode layers and an electrolyte layer between the electrode layers;
a clamping device configured to compress the cell stack;
a pressure sensor configured to detect a pressure upon the cell stack; and
a control device configured to determine a moisture content of one or more of the electrolyte layers based on the pressure.

11. The fuel cell system of claim 10, wherein the individual cells are arranged next to each other.

12. The fuel cell system of claim 10, wherein the pressure sensor is a piezo element.

13. The fuel cell system of claim 10, wherein the pressure sensor is situated between an end of the cell stack and the clamping device.

14. The fuel cell system of claim 10, further comprising a temperature sensor configured to detect a temperature of the cell stack.

15. A fuel cell system comprising:
a cell stack including individual cells of two electrode layers and an electrolyte layer;
a clamping device configured to compress the cell stack;
a pressure sensor configured to detect a cell stack pressure;
a temperature sensor configured to detect a cell stack temperature; and
a control device configured to determine a moisture content of one or more of the electrolyte layers based on the cell stack pressure and temperature.

16. The fuel cell system of claim 15, wherein the individual cells are arranged next to each other.

17. The fuel cell system of claim 15, wherein pressure sensor is a piezo element.

18. The fuel cell system of claim 15, wherein the pressure sensor is situated between an end of the cell stack and the clamping device.

19. The fuel cell system of claim 15, wherein the control device is further configured to adjust one or more operating parameters of the cell stack based on the moisture content.

20. The fuel cell system of claim 19, wherein the one or more operating parameters include a cell stack flow rate, the cell stack temperature, a cell stack moisture content, and/or the cell stack pressure.
